(19) United States
(12) Patent Application Publication
(10) Pub. No.: US 2025/0119503 A1
(43) Pub. Date: Apr. 10, 2025

(54) IMAGE READING APPARATUS AND IMAGE FORMING SYSTEM

(71) Applicant: Konica Minolta, Inc., Tokyo (JP)

(72) Inventor: Ayaka SUZUKI, Tokyo (JP)

(21) Appl. No.: 18/905,594

(22) Filed: Oct. 3, 2024

(30) Foreign Application Priority Data
Oct. 6, 2023 (JP) 2023-174369

(51) Int. Cl. H04N 1/00; B65H 5/36

(52) U.S. Cl. CPC H04N 1/00615; B65H 5/36; B65H 2511/17

(57) ABSTRACT

Provided is an image reading apparatus that reads image information of a sheet after image formation. The image reading apparatus includes: an image reader that is disposed movable in a sheet width direction orthogonal to a sheet conveyance direction and that reads the image information of the sheet; and a guide member that forms a sheet conveyance path. The guide member moves in accordance with a movement of the image reader in the sheet width direction.

### CROSS-REFERENCE TO RELATED APPLICATIONS

The present invention claims priority under 35 U.S.C. § 119 to Japanese Patent Application No. 2023-174369, filed on Oct. 6, 2023, the entire contents of which being incorporated herein by reference.

### BACKGROUND OF THE INVENTION

### Technical Field

The present invention relates to an image reading apparatus and an image forming system.

### Description of Related Art

Conventionally, there have been known image reading apparatuses that can reduce the possibility that a sheet jam occurs while an image reading means can read image information on a sheet by moving in a width direction (e.g., Japanese Unexamined Patent Publication No. 2021-182686).

In the image reading apparatus disclosed in Japanese Unexamined Patent Publication No. 2021-182686, an upstream guide shutter and a downstream guide shutter are provided to reduce the possibility of occurrence of a jam. In the aforementioned image reading apparatus, when image information on a sheet is read by the image reading means, each guide shutter is operated in a double-opening manner. Therefore, a space in which each guide shutter can be operated in a double-opening manner is required, which causes a problem that the apparatus has to be large in size. Further, a mechanism for operating each guide shutter is required, which costs higher.

### SUMMARY OF THE INVENTION

The present invention has been made in view of the above-described problems, and an object of the present invention is to provide an image reading apparatus and an image forming system capable of space saving and cost saving in reading image information on a sheet by an image reader while achieving reduction of sheet jams.

To achieve at least one of the abovementioned objects, according to an aspect of the present invention, an image reading apparatus that reads image information of a sheet after image formation includes:
an image reader that is disposed movable in a sheet width direction orthogonal to a sheet conveyance direction and that reads the image information of the sheet; and
a guide member that forms a sheet conveyance path,
wherein the guide member moves in accordance with a movement of the image reader in the sheet width direction.

According to another aspect of the present invention, an image forming system includes:
an image forming apparatus that forms an image on a sheet; and
the image reading apparatus described above.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 shows a schematic configuration of an image forming system,

FIG. 2 is a block diagram showing a functional configuration of the image forming system,

FIG. 3A is a top view of a portion indicated by A in FIG. 1,

FIG. 3B is a side view of the portion indicated by A in FIG. 1,

FIG. 4A is a top view of the portion indicated by A in FIG. 1,

FIG. 4B is a side view of the portion indicated by A in FIG. 1.

FIG. 5A is shows a state where a guide member is in contact with a far-side panel,

FIG. 5B shows a state where the guide member is in contact with a near-side panel,

FIG. 6 is a flowchart of a control procedure of image reading processing,

FIG. 7A shows another example of a guide member,

FIG. 7B shows an example of a sliding member,

FIG. 7C shows another example of the sliding member,

FIG. 8 shows another example of the guide member; and

FIG. 9 shows another example of the guide member.

### DETAILED DESCRIPTION OF EMBODIMENTS

Hereinafter, an image reading apparatus and an image forming system according to an embodiment of the present invention will be described in detail with reference to the drawings. Note that the present invention is not limited to the examples illustrated in the drawings.

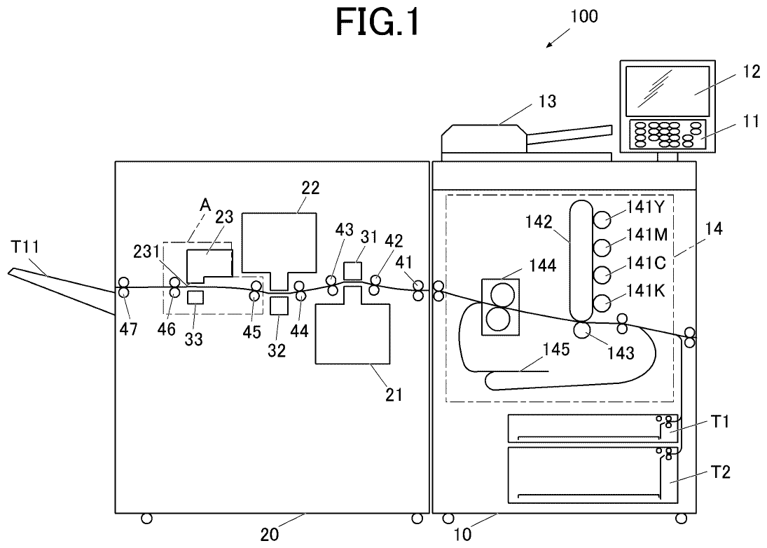

FIG. 1 shows a schematic configuration of an image forming system 100.

As illustrated in FIG. 1, the image forming system 100 includes an image forming apparatus 10 and an image reading apparatus 20. A sheet on which an image has been formed by the image forming apparatus 10 is directly carried into the image reading apparatus 20. The image forming apparatus 10 and the image reading apparatus 20 are connected so as to be able to perform data communication with each other.

The image forming apparatus 10 includes an operation part 11, a display part 12, a scanner part 13, an image forming section 14, sheet feed trays T1, T2, and the like.

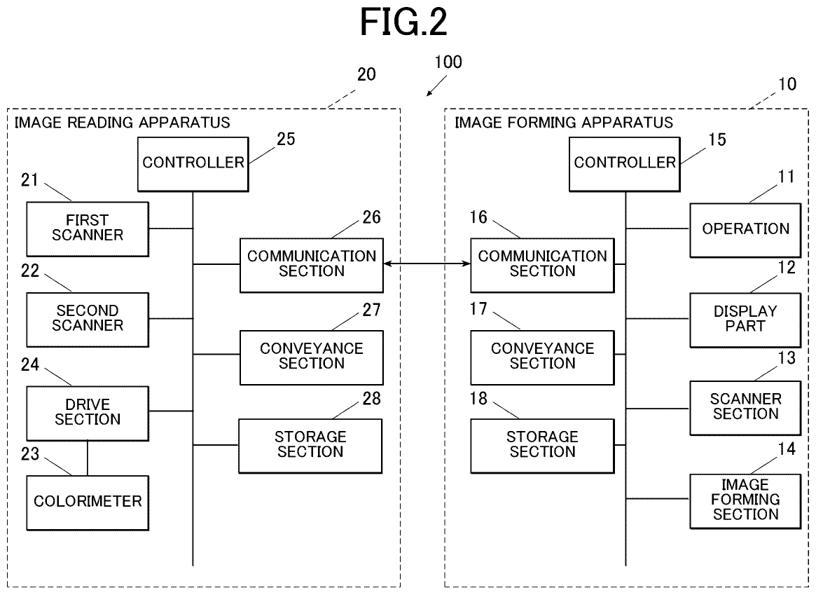

The operation part 11 includes a touch screen formed to cover a display screen of the display part 12 and various operation buttons such as numeric buttons and a start button, and outputs an operation signal based on a user's operation to a controller 15 (see FIG. 2).

The display part 12 includes a liquid crystal display (LCD) or the like and displays various screens according to an instruction of a display signal input from the controller 15.

The scanner part 13 includes an automatic document feeder (ADF), a scanner, and the like, and outputs image data obtained by reading an image of a document to the controller 15.

The image forming section 14 forms an image on a sheet on the basis of image data read by the scanner part 13 or image data received from an external device.

The image forming section 14 includes photosensitive drums 141Y, 141M, 141C, and 141K corresponding to respective colors of yellow (Y), magenta (M), cyan (C), and black (K), an intermediate transfer belt 142, a secondary transfer roller 143, a fixing section (fixer) 144, an inverting mechanism 145, and the like.

The photosensitive drum 141Y is uniformly charged and then scanned and exposed with a laser beam so that an electrostatic latent image is formed on the basis of the image data of yellow. Next, the yellow toner is adhered to the electrostatic latent image on the photosensitive drum 141Y for development of the electrostatic latent image.

The photosensitive drums 141M, 141C, and 141K work similarly to the photosensitive drum 141Y except that the respective colors are different, and thus the description thereof is omitted.

The toner images in the respective colors formed on the photosensitive drums 141Y, 141M, 141C, and 141K are sequentially transferred onto a rotating intermediate transfer belt 142 (primary transfer). That is, a color toner image in which the toner images of four colors are superimposed is formed on the intermediate transfer belt 142.

The color toner image on the intermediate transfer belt 142 is collectively transferred by the secondary transfer roller 143 onto a sheet fed from the sheet feed tray T1, T2 (secondary transfer).

The fixing section 144 includes a heating roller that heats the sheet onto which the color toner image has been transferred and a pressure roller that pressurizes the sheet and fixes the color toner image onto the sheet by heating and pressurizing.

The inversing mechanism 145 is a conveyance path for reversing the front and back of the sheet and supplying the sheet again to the secondary transfer position in a case where images are formed on both sides of the sheet.

The sheet feed trays T1, T2 store sheets of a predetermined paper type and size. The sheets stored in the sheet feed trays T1 and T2 are fed to the image forming section 14 one by one.

The image reading apparatus 20 includes a first scanner 21, a second scanner 22, a colorimeter 23 (image reader), a drive section 24, a guide member 30, a backing member 31, a backing member 32, a backing member 33, conveyance rollers 41 to 47, and a sheet ejection tray T11.

The first scanner 21, the second scanner 22, and the colorimeter 23 are provided on the downstream side of the image forming apparatus 10 in the sheet conveyance path and can read the image formed face of the sheet after the image formation before the sheet is discharged outside.

The first scanner 21 and the second scanner 22 are formed of a line sensor including charge coupled devices (CCDs) arranged in a line in a direction orthogonal to the sheet conveyance direction and parallel to the sheet surface (sheet width direction).

The first scanner 21 and the second scanner 22 read an image on the conveyed sheet and output the acquired image data to the controller 25 (see FIG. 2). The first scanner 21 and the second scanner 22 can read the entire width of the sheet.

The first scanner 21 reads the image on the side on which the image has been formed first of the sheet having images formed on both sides by the image forming apparatus 10.

The second scanner 22 reads the image on the image formed face of the sheet on one side of which the image is formed by the image forming apparatus 10, or the image on the side on which the image has been formed later of the sheet having images formed on both sides by the image forming apparatus 10.

The colorimeter (image reader) 23 is a spectral colorimeter which detects a spectral reflectance for each wavelength for the image formed on the sheet and measures the color of the image. The colorimeter 23 is capable of reading only a partial area in the direction orthogonal to the sheet conveyance direction and parallel to the sheet surface (sheet width direction).

The colorimeter 23 includes an image reading section 231 on a lower surface side facing the conveyed sheet. The image reading section 231 reads colors of an image (color patch) formed on a sheet by the image forming apparatus 10. The image reading section 231 has a radius of about 4 mm.

When the image (color patch) formed on the sheet is read by the image reading section 231 of the colorimeter 23, the drive section 24 slides the colorimeter 23 in the sheet width direction so that the image reading section 231 is positioned at a desired reading position. An example of a driving source in the drive section 24 is a servomotor.

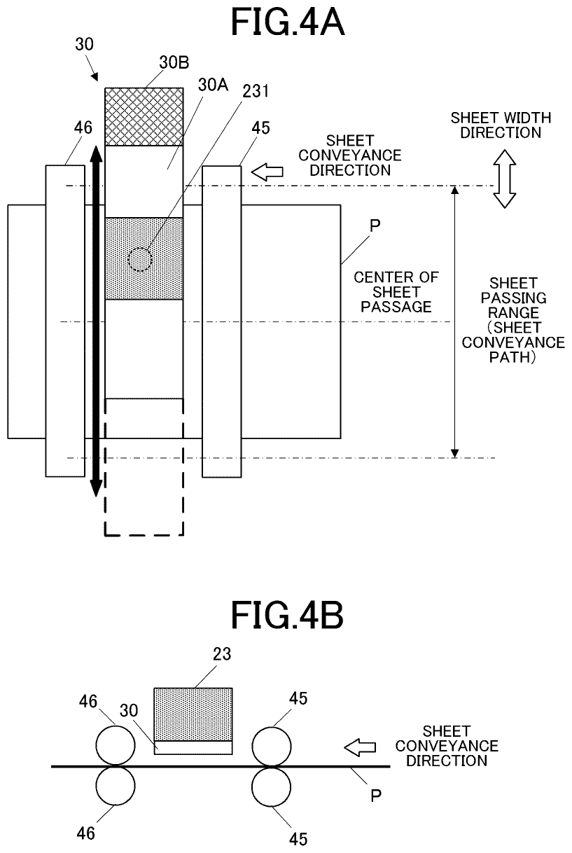

The guide member 30 forms a sheet conveyance path between the conveyance roller 45 and the conveyance roller 46. The guide member 30 is disposed above the sheet passing between the conveyance roller 45 and the conveyance roller 46, and restricts lifting of the sheet. That is, the guide member 30 has a function of reducing the occurrence of a jam of the sheet between the conveyance roller 45 and the conveyance roller 46. The colorimeter 23 is disposed on a first guide 31 (described later) included in the guide member 30. That is, the guide member 30 is configured to slidably move along with the sliding movement of the colorimeter 23 in the sheet width direction (see FIG. 4).

The backing member 31 is a member serving as a background of the sheet when the image formed on the sheet is read by the first scanner 21.

The backing member 32 is a member serving as a background of the sheet when the image formed on the sheet is read by the second scanner 22.

The backing member 33 is provided at a position facing the image reading section 231 of the colorimeter 23 and is a member serving as a background of the sheet when the image formed on the sheet is read by the colorimeter 23.

The conveyance rollers 41 to 47 convey the sheet in the image reading apparatus 20.

A sheet that has passed through the image reading apparatus 20 is ejected onto the sheet ejection tray T11.

FIG. 2 is a block diagram showing a functional configuration of the image forming system 100.

As shown in FIG. 2, the image forming apparatus 10 includes the operation part 11, the display part 12, the scanner part 13, the image forming section 14, the controller 15, a communication section 16, a conveyance section 17, and a storage section 18. Description of the functional components already described will be omitted.

The controller 15 includes a central processing unit (CPU), a read only memory (ROM), and a random access memory (RAM), and the like.

The CPU reads out various processing programs stored in the ROM, deploys the programs into the RAM, and centrally controls operations by each component of the image forming apparatus 10 in accordance with the deployed programs.

The communication section 16 transmits and receives data to and from the image reading apparatus 20 connected thereto by a predetermined cable. Further, the communication section 16 transmits and receives data to and from an external device connected to a communication network such as a local area network (LAN).

The conveyance section 17 includes conveyance rollers for conveying a sheet and conveys a sheet in the image forming apparatus 10.

The storage section 18 includes a hard disk and a flash memory and stores various data. For example, the storage section 18 stores image data for generating a calibration chart including a plurality of color patches.

The image reading apparatus 20 includes a first scanner 21, a second scanner 22, a colorimeter 23, a drive section 24, a controller 25, a communication section 26, a conveyance section 27, a storage section 28, and the like. Description of the functional components already described will be omitted.

The controller 25 includes a CPU, a ROM, a RAM, and the like. The CPU reads out various processing programs stored in the ROM, deploys the programs into the RAM, and centrally controls operations by each component of the image reading apparatus 20 in accordance with the deployed programs.

The controller 25 calculates adjustment values of the image forming section 14 based on the reading results of the first scanner 21 and the second scanner 22. The adjustment values include parameters for adjusting the color, position, magnification, and the like of the image in the image forming apparatus 10.

In the calibration mode, the controller 25 calibrates the output values of the first scanner 21 and the second scanner 22 based on the color information of the first scanner 21 and the second scanner 22 with respect to the calibration chart including the color patches and the color information of the colorimeter 23. Since the second scanner 22 can read the same surface as the colorimeter 23, the second scanner 22 is calibrated so that the color information of the second scanner 22 for each color patch corresponds to the color information of the colorimeter 23. On the other hand, since the first scanner 21 cannot read the same surface (the same color patch) as the colorimeter 23, the first scanner 21 and the colorimeter 23 read each color patch formed under the same condition by the image forming section 14, and the first scanner 21 is calibrated so that the color information of the first scanner 21 corresponds to the color information of the colorimeter 23.

The communication section 26 transmits and receives data to and from the image forming apparatus 10 connected thereto by a predetermined cable. Specifically, the communication section 26 transmits the adjustment values calculated from the reading results of the first scanner 21 and the second scanner 22 to the image forming apparatus 10.

The conveyance section 27 includes conveyance rollers 41 to 47 for conveying the sheet and conveys the sheet in the image reading apparatus 20.

The storage section 28 includes a hard disk, a flash memory, or the like, and stores various types of data.

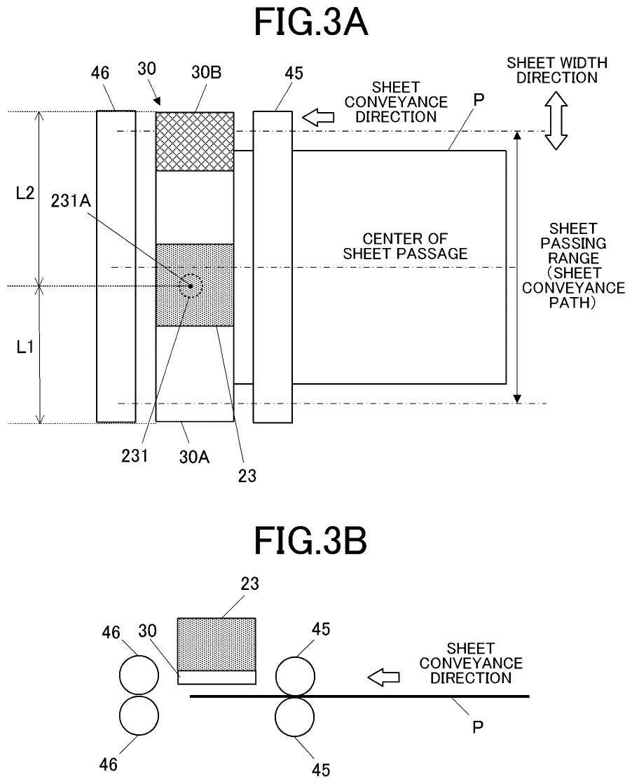

FIG. 3A is a top view of a portion indicated by A in FIG. 1, and FIG. 3B is a side view of the portion indicated by A in FIG. 1. FIGS. 3A and 3B show a state in which a sheet P is conveyed between the conveyance roller 45 and the conveyance roller 46.

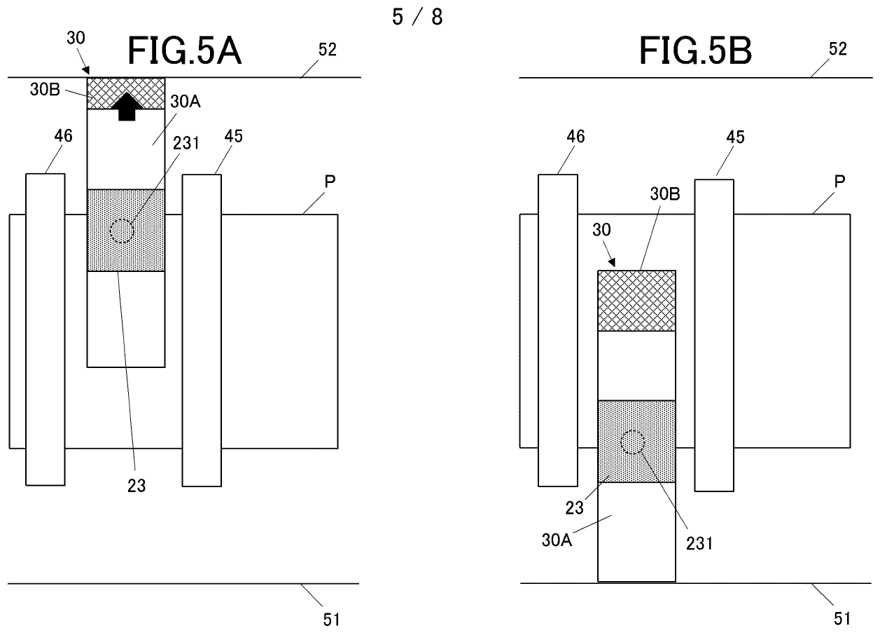

The guide member 30 is a substantially rectangular flat plate member disposed between the conveyance roller 45 and the conveyance roller 46. The guide member 30 is designed such that its length in the longitudinal direction is longer than a sheet passing range (sheet-passable range) of the sheet P. To be more specific, the guide member 30 includes a first guide 30A and a second guide 30B. The second guide 30B is connected to the first guide 30A so as to be slidable in the sheet width direction by stretching and contracting. A spring (not shown in the drawings) is interposed between the first guide 30A and the second guide 30B. This spring is for restoring the second guide 30B to the original position when the state in which the second guide 30B has slid toward the first guide 30A (contracting state; see FIG. 5A) is released. The colorimeter 23 is placed on the upper surface of the first guide 30A. The first guide 30A is provided with an opening (not shown) through which the image reading section 231 of the colorimeter 23 can face the sheet P through the guide member 30.

As shown in FIGS. 3A and 3B, when the sheet P is conveyed between the conveyance roller 45 and the conveyance roller 46, the guide member 30 is arranged at a position covering the entire sheet passing range in order to ensure the conveyability of the sheet P and reduce the occurrence of a jam. That is, when the sheet P is conveyed between the conveyance roller 45 and the conveyance roller 46, the colorimeter 23 and the guide member 30 are in a stopped state without sliding in the sheet width direction. At this time, the center (color measurement center) 231A of the image reading section 231 of the colorimeter 23 is located at a position shifted toward the front from the center (sheet passage center) of the sheet conveyance path in the sheet-width direction and opposite to the sheet conveyance path. That is, the guide member 30 is provided such that the portion extending on one side (the front side) of the colorimeter 23 in the sheet-width direction, L1, and the portion extending on the other side (the back side), L2, are asymmetric with respect to the image reading section 231. In other words, the guide member 30 is provided such that the portion of the guide member 30 extending to the other side (far side) of the colorimeter 23, L2, is longer than the portion extending to the one side (near side), L1. Here, it is preferable that the difference (L2−L1) between the length L2 of the portion extended on the other side and the length L1 of the portion extended on the one side of the colorimeter 23 exceeds 10% of the widths of the sheet passing ranges.

FIG. 4A is a top view of the portion indicated by A in FIG. 1, similarly to FIG. 3A. FIG. 4B is a side view of the portion indicated by A in FIG. 1, similarly to FIG. 3B FIG. 4A and FIG. 4B show how the image reading section 231 of the colorimeter 23 reads an image.

As shown in FIGS. 4A and 4B, when the image reading section 231 reads an image, the conveyance of the sheet P by the conveyance roller 45 and the conveyance roller 46 is stopped, and the colorimeter 23 slides and moves to a desired image reading position in the sheet width direction. At this time, along with the sliding movement of the colorimeter 23 in the sheet width direction, the guide member 30 also slides.

FIG. 5A shows a state where the guide member 30 is in contact with a far-side panel 52 that restricts sliding movement of the guide member 30.

As shown in FIG. 5A, the guide member 30 can slide to a position where the second guide 30B is brought into contact with the far-side panel 52 when the guide member 30 slides in the sheet width direction (toward the far side) as the colorimeter 23 slides in the sheet width direction (toward the far side). Here, as described above, the second guide 30B is connected to the first guide 30A so as to be slidable in the sheet width direction by contracting and stretching. Therefore, the colorimeter 23 on the first guide 30A can further slide in the sheet width direction (toward the far side) even after the second guide 30B has been brought into contact with the far-side panel 52. Thus, the image reading section 231 of the colorimeter 23 can reach the end of the sheet P.

FIG. 5B shows a state where the guide member 30 is in contact with a near-side panel 51 that restricts sliding movement of the guide member 30.

As shown in FIG. 5B, the guide member 30 can slide to a position where it is brought into contact with the near-side panel 51 when the guide member 30 slides in the sheet width direction (toward the near side) as the colorimeter 23 slides in the sheet width direction (toward the near side). At this time, as described above, the center 231A of the image reading section 231 of the colorimeter 23 is at a position shifted to the near side from the center (sheet passage center) of the sheet conveyance path in the sheet width direction, and therefore, when the guide member 30 slides and moves in the sheet width direction (to the near side), the image reading section 231 of the colorimeter 23 can reach the end portion of the sheet P.

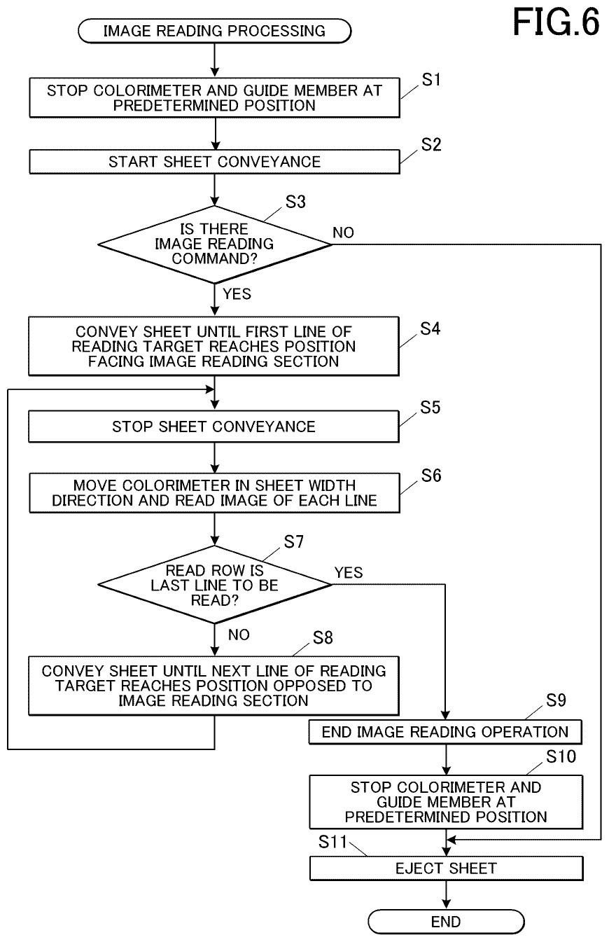

Next, image reading processing to be executed by the image reading apparatus 20 will be described with reference to FIG. 6. FIG. 6 is a flowchart of a control procedure of the image reading processing.

As shown in FIG. 6, when the image reading processing is started, the controller 25 of the image reading apparatus 20 controls the drive section 24 to stop the colorimeter 23 and the guide member 30 at predetermined positions (Step S1). More specifically, as shown in FIG. 3A, the colorimeter 23 and the guide member 30 are stopped when the colorimeter 23 and the guide member 30 reach respective positions where the colorimeter 23 and the guide member 30 cover the entire sheet passing range.

Next, the controller 25 causes the conveyance roller 45 and the conveyance roller 46 to start conveying the sheet P (Step S2).

Next, the controller 25 determines whether or not a command for reading an image on the sheet P that has started to be conveyed has been given (Step S3).

When determining in Step S3 that a command for reading the sheet P that has started to be conveyed has not been given (Step S3; NO), the controller 25 proceeds to Step S11.

When determining in Step S3 that a command for reading the image on the sheet P that has started to be conveyed has been given (YES in step S3), the controller 25 causes the conveyance roller 45 and the conveyance roller 46 to convey the sheet P until the first line to be read reaches a position facing the image reading section 231 (Step S4).

Next, the controller 25 stops the conveyance of the sheet P by the conveyance roller 45 and the conveyance roller 46 (Step S5).

Next, the controller 25 controls the drive section 24 to move the colorimeter 23 in the sheet width direction, and the image reading section 231 reads the image of each line (Step S6).

Next, the controller 25 determines whether or not the line of the sheet P read in Step S6 is the final line to be read (final read line) (Step S7).

When determining in Step S7 that the line of the sheet P read in Step 6 is not the last line to be read (Step S7; NO), the controller 25 causes the conveyance roller 45 and the conveyance roller 46 to convey the sheet P until the next line to be read reaches a position facing the image reading section 231 (Step S8). Then, the controller 25 returns to Step S5, and repeats the subsequent processing.

Furthermore, when it is determined in Step S7 that the line of the sheet P read in Step 6 is the last line to be read (Step S7; YES), the controller 25 ends the image reading operation (Step S9).

Next, the controller 25 controls the drive section 24 to stop the colorimeter 23 and the guide member 30 at predetermined positions (step S10). More specifically, as shown in FIG. 3A, the colorimeter 23 and the guide member 30 are stopped when the colorimeter 23 and the guide member 30 reach respective positions where the colorimeter 23 and the guide member 30 cover the entire sheet passing range.

Next, the controller 25 causes the conveyance roller 45 and the conveyance roller 46 to convey the sheet P and causes the sheet P to be ejected from between the conveyance roller 45 and the conveyance roller 46 (Step S11). Then, the controller 25 ends the image reading processing.

As described above, the image reading apparatus 20 includes the colorimeter (image reader) 23 that is disposed movable in the sheet width direction orthogonal to the sheet conveyance direction and that reads the image information of the sheet P, and the guide member 30 that forms the sheet conveyance path. The guide member 30 moves with the movement of the colorimeter 23 in the sheet width direction. Thus, when the colorimeter 23 is moved in the sheet width direction, a space for retracting the guide member 30 to the retraction position is unnecessary, and a mechanism for performing the retracting operation is also unnecessary. As a result, space saving, and cost saving is attainable in reading the image information on a sheet by the colorimeter 23 while achieving reduction of sheet jams.

Furthermore, during sheet conveyance, the image reading section 231 (the color measurement center 231A) of the colorimeter 23 that reads image information is disposed at a position that is shifted from the center (sheet passage center) of the sheet conveyance path in the sheet width direction and that faces the sheet conveyance path. The guide member 30 is extended to one side and the other side of the colorimeter 23 in the sheet width direction, and the length of a portion extended to one side and the length of a part extended to the other side are asymmetric with respect to the image reading section 231. Thus, since the arrangement of the colorimeter 23 can be shifted to the near side or the far side of the apparatus to make a difference in the moving distance of the colorimeter 23 during sheet conveyance, that is, when the colorimeter 23 is stopped, the reading of the image information of the sheet by the colorimeter 23 and the reduction of sheet jams are attainable while keeping the restriction of the machine size in the image reading apparatus 20.

Further, the guide member 30 includes a first guide 30A and a second guide 30B, and the first guide 30A and the second guide 30B are disposed to be slidable along with the sheet width direction by stretching and contracting. Therefore, even after the second guide 30B has been brought into contact with the far-side panel 52, the colorimeter 23 can slide in the sheet width direction (toward the far side) while the second guide 30B is contracting toward the first guide 30A side. As a result, limitations on the layout of the colorimeter 23 and the guide member 30 can be alleviated.

The description in the above embodiment is an example of the image reading apparatus and the image forming system according to the present invention, and the present invention is not limited to this.

For example, in the above embodiment, the guide member 30 is provided such that the length L2 (see FIG. 3) the portion extending on the other side (far side) of the colorimeter 23 is longer than the length L1 (see FIG. 3) of the portion extending on the one side (near side), but this layout is merely an example. For example, the guide member 30 may be provided such that the length L2 of the portion the guide member 30 extending toward the other side (far side) of the colorimeter 23 is shorter than the length L1 of the portion of the guide member 30 extending toward the one side (near side) of the colorimeter 23.

In the above embodiment, the guide member 30 includes the first guide 30A and the second guide 30B. However, the guide member 30 may include only the first guide 30B without the second guide 30A. Here, when the sheet P is being conveyed, the center 231A of the image reading section 231 of the colorimeter 23 is preferably arranged at a position that is shifted from the center of the sheet conveyance path toward the front side in the sheet width direction and that faces the sheet conveyance path. At this time, the center 231A of the image reading section 231 of the colorimeter 23 may be arranged at a position that is shifted from the center of the sheet conveyance path toward the far side in the sheet width direction.

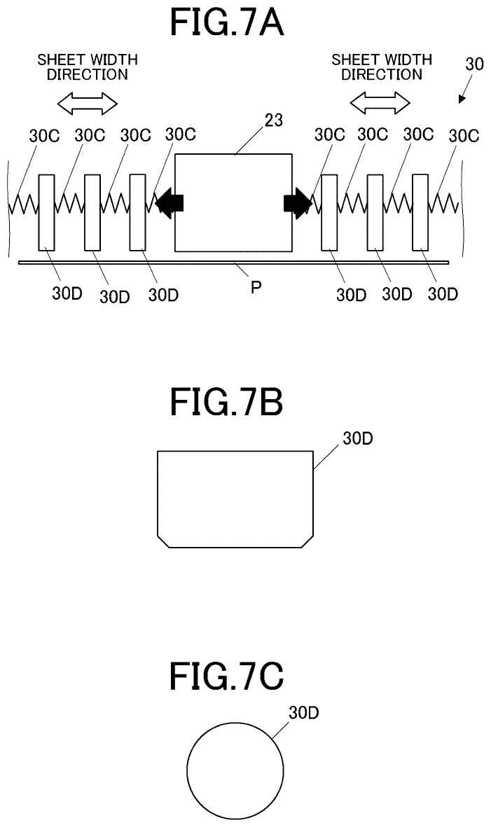

Furthermore, in the above embodiment, the guide member 30 includes the first guide 30A and the second guide 30B, but this configuration is merely an example. For example, as shown in FIG. 7A, the guide member 30 may be formed by a plurality of elastic members (e.g., springs) 30C and a plurality of sliding members 30D. To be specific, the elastic members 30C and the sliding members 30D are alternately provided on both sides (both sides in the sheet width direction) of the colorimeter 23. The sliding members 30D are formed of a material such as a resin. The shape of the side surfaces of the sliding members 30D (the surface to which the elastic members 30C are connected) is not particularly limited, but examples thereof include a substantially rectangular shape and a circular shape, as shown in FIG. 7B and FIG. 7C.

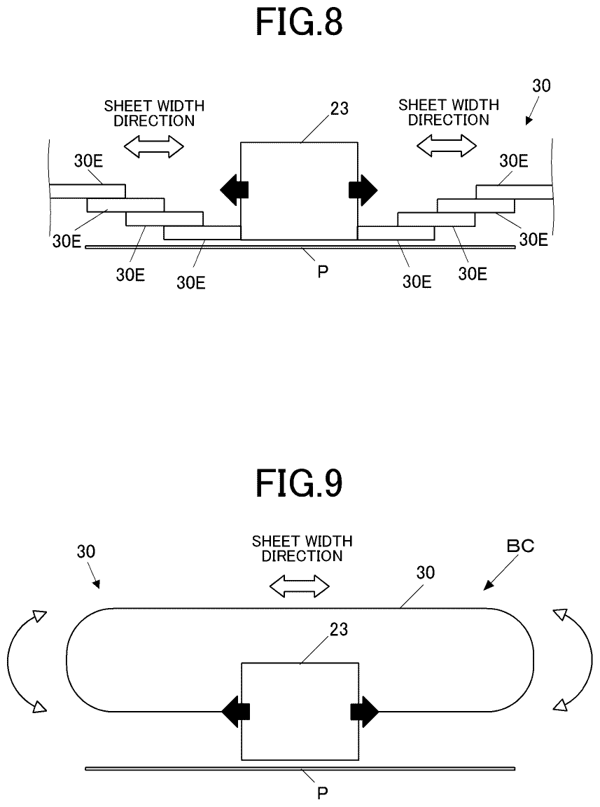

Further, as shown in FIG. 8, the guide member 30 may include a plurality of stacking members 30E. To be more specific, the plurality of stacking members 30E are provided on both sides of the colorimeter 23 (both sides in the sheet width direction). The stacking members 30E are provided such that vertically adjacent stacking members 30E are engaged with each other and can slide relative to each other in the sheet width direction.

Further, as shown in FIG. 9, a belt conveyor BC capable of moving (slidably) the colorimeter 23 in the sheet width direction may be provided, and a belt member of the belt conveyor BC may function as the guide member 30. The belt member functioning as the guide member 30 is preferably formed of a slippery member that does not restrict sheet conveyance, such as a metal like stainless steel or a resin. Although not shown in FIG. 9, a pulley that transmits a force from the belt member (the guide member 30) to a shaft may be provided, or a guide may be provided outside the belt conveyor BC. Furthermore, the belt conveyor BC is not limited to one that circulates the belt member (the guide member 30). For example, a flat belt member may be used as the belt member (the guide member 30), and the belt conveyor BC may bridge this belt member at least over the sheet passing range. On both ends on which the belt member is bridged, winding frames are provided so that the belt member can be taken in and out, and when the belt member is unwound from one winding frame, the unwound portion of the belt member can be wound up by the other winding frame. Furthermore, a chain conveyor or the like may be used instead of the belt conveyor BC.

In addition, it is a matter of course that the detailed configuration and the detailed operation of each constituent element of the image reading apparatus 20 and the image forming system 100 in the above embodiment can be appropriately changed without departing from the spirit of the present invention.

1. An image reading apparatus that reads image information of a sheet after image formation, the image reading apparatus comprising:
an image reader that is disposed movable in a sheet width direction orthogonal to a sheet conveyance direction and that reads the image information of the sheet; and
a guide member that forms a sheet conveyance path,
wherein the guide member moves in accordance with a movement of the image reader in the sheet width direction.

2. The image reading apparatus according to claim 1,
wherein when the sheet is conveyed, an image reading section that reads the image information is disposed at a position that is shifted from a center of the sheet conveyance path in the sheet width direction and that faces the sheet conveyance path.

3. The image reading apparatus according to claim 2,
wherein the guide member comprises:
a first guide extending on one side of the image reader in the sheet width direction; and a second guide extending on an opposite side of of the one side of the image reader in the sheet width direction,
wherein a length of the first guide and a length of the second guide are asymmetric with respect to the image reading section.

4. The image reading apparatus according to claim 3,
wherein the image reader is provided on the first guide or the second guide.

5. The image reading apparatus according to claim 3,
wherein in the guide member, the first guide and the second guide are disposed to be slidable along with the sheet width direction by stretching and contracting.

6. The image reading apparatus according to claim 1,
wherein the guide member includes a stretchable member.

7. The image reading apparatus according to claim 6,
wherein the stretchable member includes: a plurality of sliding members; and a plurality of elastic members that respectively connects the plurality of sliding members movable in the sheet width direction.

8. The image reading apparatus according to claim 6,
wherein the stretchable member includes a plurality of stacked members that is disposed such that adjacent ones of the plurality of stacked members are slidable with respect to each other.

9. The image reading apparatus according to claim 1, further comprising:
a belt conveyor capable of moving the image reader in the sheet width direction,
wherein the guide member is a belt member included in the belt conveyor.

10. An image forming system comprising:
an image forming apparatus that forms an image on a sheet; and
the image reading apparatus according to claim 1.
